(19) United States
(12) Patent Application Publication
(10) Pub. No.: US 2010/0091005 A1
(43) Pub. Date: Apr. 15, 2010

(54) ACTIVE MATRIX DISPLAY DEVICE

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/526,514

(22) PCT Filed: Jan. 22, 2008
(86) PCT No.: PCT/US08/00746

§ 371 Date: Aug. 10, 2009

(51) Int. Cl. G06F 3/038; G09G 3/30

(52) U.S. Cl. 345/213; 345/76

(57) ABSTRACT

A data writable and readable pixel is provided. The pixel includes a transistor which is turned on or off by a selection signal on a selection line; a static memory (a memory including two drive transistors connected to a data line through the transistor; and light emitting devices undergoing control of light emitting according to the storage state of the static memory. In a write mode, the selection transistor is turned on, while, at the same time, data on the data line is set to write the data in the static memory. In a read mode, the selection transistor is turned on, and, at the same time, the data line is set to a floating state, and the stored content of the static memory is read onto the data line.

The present invention relates to an active matrix type display device supplying data to pixels arranged in a matrix manner for display.

### BACKGROUND OF THE INVENTION

Because active matrix type display devices are generally capable of displaying images with a higher resolution than passive matrix displays, active matrix display have come to be widely used in display applications. In an active matrix type display device, each pixel is provided with an active device for determining its display state. For example, a drive transistor may be provided in a current drive type display device such as an organic electroluminescent (EL) display device, wherein the drive transistor may continue supplying current to a light emitting device. Although attempts have been made to employ thin film transistors (TFT) including a thin film of a material such as amorphous silicon and poly-silicon as drive transistors, producing TFTs with uniform characteristics has proven problematic.

Correction of the characteristics of a TFT by use of circuit technology have been proposed. One proposal is the digital drive technology disclosed in WO 2005-5116971 (A1).

A conventional example has a configuration in which pixels are provided with holding capacitors and written data are held in the holding capacitor for a fixed time period to generate emission intensity corresponding to the data. That is, the holding capacitor is used as a write-only dynamic memory. Accordingly, a memory that is both readable and writable must provided as an external component, and a refresh operation in which data is rewritten into the holding capacitor is required.

The above refreshing operation is one factor which impedes attempts to reduce power consumption, because the refreshing operation is required even when the displayed image does not change. Moreover, the need to provide an external memory is required when only a write-only operation is performed for each pixel makes it difficult to further reduce production costs of a display device.

### SUMMARY OF THE INVENTION

One aspect of the present invention is an active matrix type display device, including a plurality of pixels arranged in a matrix manner; data lines which are arranged along the column direction of pixels and on which data for pixels corresponding to columns is set; and selection lines which are arranged along the row direction of pixels and on which selection signals are set, wherein each pixel includes a selection transistor which is turned on or off by a selection signal on the selection line; a static memory connected to the data line through the selection transistor; and a light emitting device undergoing control of light emitting according to the storage state of the static memory, and, in a write mode, the selection transistor is turned on, and, at the same time, data set on the data line is set to write the set data in the static memory, and in a read mode, the selection transistor is turned on, and, at the same time, the data line is made in a floating state, and the stored content of the static memory is read onto the data line.

Preferably, the light emitting device includes a first light emitting device and a second light emitting device, with one of the devices being shielded, and the other being not shielded, and the static memory includes a first drive transistor which is connected to the first light emitting device, and controls a current input to the first light emitting device; and a second drive transistor which is connected to the second light emitting device, and controls a current input to the second light emitting device, and the control terminal of the first light emitting device is connected to a data line through the selection transistor, and, at the same time, is connected to a node of the second drive transistor and the second light emitting device, the control terminal of the second light emitting device is connected to a node of the first drive transistor and the first light emitting device, and data is written from a data line through the selection transistor, wherein either of the first drive transistor or a second transistor is turned on according to data supplied to the control terminal of a first transistor.

Moreover, it is preferable that the on resistance of the selection transistor is set higher than the resistance of the second light emitting device and the on resistance of the second drive transistor.

Furthermore, it is preferable that data may be read onto a data line by a configuration in which the on resistance of the selection transistor is set higher than that of the second drive transistor, and, at the same time, the data line is precharged before a read operation of the data is started in a read mode to make the on resistance of the selection transistor higher than that of the second drive transistor.

Moreover, it is preferable that the on resistance in a read mode is made higher that that in a write mode by employing a configuration in which a voltage level of a selection signal supplied to the selection line is set higher in the write mode, and lower in the read mode.

Furthermore, it is preferable that there is further provided a data line with a second selection transistor connecting the control terminal of the second drive transistor and the node of the first drive transistor and the first light emitting device, one of the on resistance of the selection transistor and that of the second selection transistor is set higher than the other one, and in a write mode, the selection transistor with a lower on resistance is turned on, and, in a read mode, the selection transistor with a higher on resistance is turned on.

Moreover, it is preferable that, when data is read form the pixel, data read through one of the two selection transistors and inverted data read through the other selection transistor are compared for verifying of the read data.

Furthermore, it is preferable that a part of the pixels function as the light emitting device to pass a current therethrough, but not to emit visible light at that time, and pixels which do not emit light are used as a data writable and readable memory.

Moreover, it is preferable that the light emitting device is an organic EL device.

As described above, data may be written into each pixel, and, furthermore, data may be read out therefrom according to the present invention. Accordingly, written data may be read for use as required.

### BRIEF DESCRIPTION OF THE DRAWINGS

FIG. 1A shows an equivalent circuit of a first pixel;

FIG. 1B shows the wiring and configuration of the first pixel;

FIG. 2 shows a general view of a first organic EL display device;

FIG. 3 shows a timing chart for a data write and read operation;

FIG. 4A shows an equivalent circuit of a second pixel;

FIG. 4B shows the wiring and configuration of the second pixel;

FIG. 5 shows a general view of a second organic EL display device;

FIG. 6 is an explanatory view of masks used for manufacturing an organic EL display device;

FIG. 7 shows an equivalent circuit of a pixel other than that shown in FIG. 1A; and

FIG. 8 shows an equivalent circuit of a pixel other than that shown in FIG. 4A.

### DESCRIPTION OF THE PREFERRED EMBODIMENT

Hereinafter, an embodiment according to the present invention will be explained referring to drawings.

### Pixel Circuit

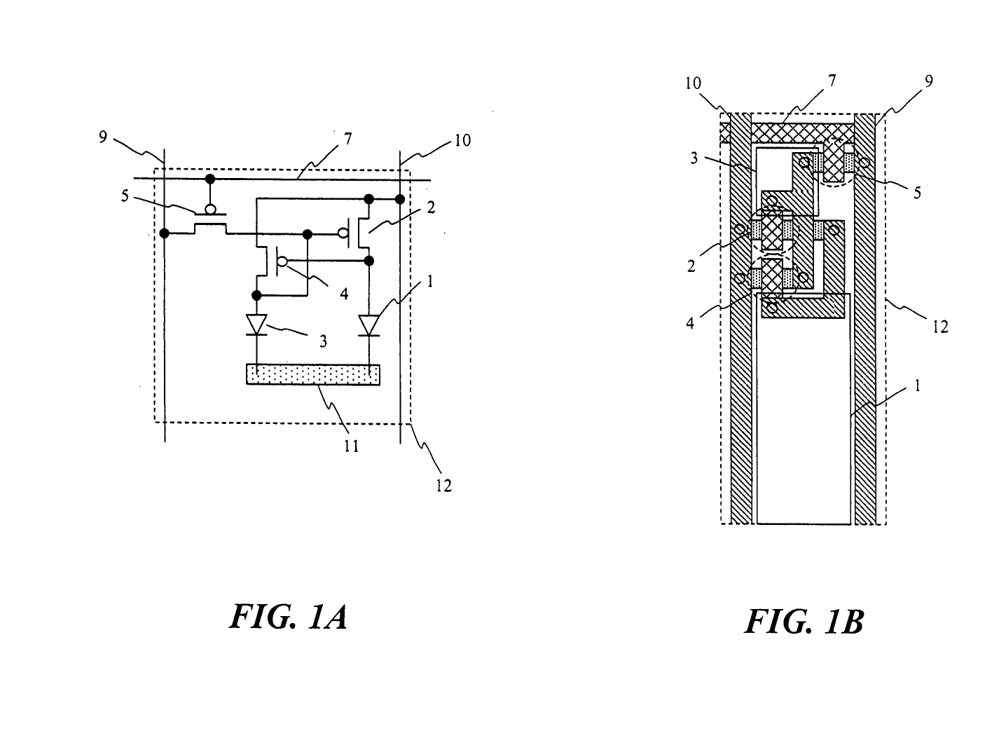

FIG. 1A and FIG. 1B show a configuration of a pixel 12 according to the present embodiment. FIG. 1A shows a pixel equivalent circuit, and FIG. 1B shows the wiring and arrangement of a pixel circuit as seen from the rear, the side other than the light-emitting surface.

The pixel shown in FIG. 1A and FIG. 1B includes a first organic EL device 1 contributing to light-emitting; a first drive transistor 2 driving the device 1; a second organic EL device 3 which does not contribute to light-emitting; and a second drive transistor 4 driving the EL device 3. Additionally, a gate transistor 5 controls supply of a data voltage which is supplied, via a data line 9, to a gate terminal of the first drive transistor 2, wherein a gate line 7 to which a selection signal is supplied controls an on/off operation of the transistor 5. As described above, the pixel 12 shown in FIG. 1 does not require a holding capacitor as required in the conventional art.

The anode of the first organic EL device is connected to the drain terminal of the first drive transistor 2 and the gate terminal of the second drive transistor 4. The gate terminal of the first drive transistor 2 is connected to a node of the anode of the second organic EL device 3 and the drain terminal of the second drive transistor 4, and to the source terminal of the gate transistor 5. The gate terminal of the gate transistor 5 is connected to the gate line 7, and the drain terminal thereof is connected to the data line 9. The source terminal of the first drive transistor 2 and that of the second drive transistor 4 are connected to a power supply line 10, and the cathode of the first organic EL device 1 and that of the second organic EL device 3 are connected to a cathode electrode 11.

The pixel shown in FIG. 1 has a configuration in which a write operation writing data which is supplied to the data line 9 into a pixel, and a read operation reading data which is held in a pixel onto the data line 9 may be realized by supplying an appropriate selection voltage to the gate transistor 5. Methods for realizing the write operation and the read operation will next be explained based on this configuration.

### Write Operation

First, with regard to the write operation, it is required for writing data that the write can invert a held data. Accordingly, an operation for inverting level will be explained hereinafter.

When the gate line 7 is selected (set to low) and the gate transistor 5 is turned on, the data line 9 is connected to the gate terminal of the first drive transistor 2, and the node of the anode of the second organic EL device 3 and the drain terminal of the second drive transistor 4 through the gate transistor 5.

When the data voltage supplied onto the data line 9 is low and the held data is high, the gate terminal of the first drive transistor 2 is maintained high, and the first organic EL device 1 does not emit light because the second drive transistor 4 is turned on. In this case, in order to invert the gate terminal of the first drive transistor 2 from high to low, the on resistance of the gate transistor 5 must be lower than that of the second drive transistor 4 because the intensity of the high signal held in the gate terminal of the first drive transistor 2 depends on the on resistance of the second drive transistor 4. When the on resistance of the gate transistor 5 is larger than that of the second drive transistor 4, data may not be inverted from high to low, even if a low signal is supplied to the data line 9, because the potential of the gate terminal of the first drive transistor 2 does not become low by resistance voltage division, and the potential remains on the high side.

In consideration of these factors, the size of the gate transistor 5 must be set such that the on resistance of the transistor 5 is smaller than that of the second drive transistor 4, or, if the resistances are the same as each other or the inequality is inverted, that the selection voltage supplied to the gate line 7 (a voltage turning the gate transistor 5 on) is reduced and the transistor 5 is operated under a lower resistance condition.

When the above-described conditions are satisfied, the gate voltage of the first drive transistor 2 becomes low, and the first drive transistor 2 is turned on. When the first drive transistor 2 is turned on, the anode of the first organic EL device 1 is connected to the power supply line 10 to which a power-supply voltage VDD is supplied, and a current passes through the first organic EL device 1 to emit light. At the same time, the voltage at the gate terminal of the second drive transistor 4 becomes VDD, too, and the second drive transistor 4 is turned off. Thereby, the voltage at the anode of the second organic EL device 3 is reduced approximately to a cathode potential VSS. In more specific terms, the low voltage supplied to the data line 9 and the cathode potential VSS become a level divided by the on resistance of the gate transistor 5 and the resistance of the second organic EL device 3.

As the above voltage near the cathode potential VSS is supplied to the gate terminal of the first drive transistor 2, the written low level is maintained while VDD and VSS are applied after the gate line 7 is set high and the gate transistor 5 is turned off.

Then, when the data held in the gate terminal of the first drive transistor 2 is low, and written data is inverted by supplying high level to the data line 9, the on resistance of the gate transistor 5 must be lower than the resistance of the second organic EL device 3. If the on resistance of the gate transistor 5 is higher than the resistance of the second organic EL device 3, the potential of the gate of the first drive transistor 2 remains low, and the data is not inverted because the potential depends on the voltage division of the on resistance of the gate transistor 5 and the resistance of the second organic EL device 3.

When the on resistance of the gate transistor 5 is fully lower than the resistance of the second organic EL device 3, the gate voltage of the first drive transistor 2 becomes high level as a result of as a result of resistance division, to thereby cause a state in which the first drive transistor 2 is turned off, while the potential of the anode of the first organic EL device 1 is reduced to the cathode potential VSS. When the above cathode potential VSS is supplied to the gate terminal of the second drive transistor 4, the second drive transistor 4 is turned on, the anode of the second organic EL device 3 is connected to the power supply line 8 to which the power-supply voltage VDD is supplied, and a current passes through the second organic EL device 3. Because the anode potential of the second organic EL device 3 is reflected in the gate terminal of the first drive transistor 2 and becomes the power-supply voltage VDD, the written high level is maintained while VDD and VSS are applied after the gate line 7 is set high and the gate transistor 5 is turned off.

Here, as the second organic EL device 3 does not contribute to light emission, the light emitting state of a pixel depends solely on the light emitting state of the first organic EL device 1.

Methods for forming the second organic EL device 3 which does not contribute to light emission include a method in which a non-light emitting device separate from the first organic EL device 1, but this method is complex because two devices, the first organic EL device 1 emitting light and the organic EL device 3 which does not emit light, must be formed. Especially, a mask for preventing formation of a light emitting device in a region in which a non-light emitting device is formed is required during production of the light emitting device, and the high accuracy required for this mask increases the manufacturing complexity and cost. Accordingly, an simple and cost advantageous method in which both devices are similarly formed, and the second organic EL device 3 is shielded with wiring for forming pixels, a black matrix, or the like to prevent light from being emitted from the light-emitting surface to the outside.

Moreover, as a current passes through the second organic EL device 3 when the first organic EL device 1 does not emit light, it is preferable from the viewpoint of power consumption to increase the resistance of the second organic EL device 3 in such a way that the current is smaller.

That is, as the second organic EL device 3 does not contribute to light emission, and the higher resistance may be more easily controlled, it is preferable to create the arrangement and the wirings as shown in FIG. 1B in such a way that the smaller light emitting area of the second organic EL device 3 and the larger light emitting area of the first organic EL device 1 which emits light are secured.

### Read Operation

An example read operation will next be described. When the write operation is reversed, and data held in a pixel is correctly read through the data line 9, t so-called “improper writing”, that is, data supplied to the data line 9 rewriting the data held in a pixel, must be prevented. Such improper writing may be caused when data held in the data line 9 is different from data held in a pixel. Accordingly, an example of improper writing will first be described.

When the gate line 7 is selected (set low), and the gate transistor 5 is first turned on, the data line 9 is connected to the gate terminal of the first drive transistor 2 and the node of the second organic EL device 3 and the drain terminal of the second drive transistor 4 through the gate transistor 5 in a similar manner to that of the write operation. Under such circumstances, the data line 9 is in a floating state in order to maintain the previous high or low state using its own capacitor.

Now, there will be considered a case in which the data held in the data line 9 is high, and the data held in the gate terminal of the first drive transistor 2 is low, that is, the second drive transistor 4 is turned off.

If the on resistance of the gate transistor 5 is left smaller than the resistance of the second organic EL device 3 in a similar manner to that during writing, the high level held in the data line 9 is written over the held data, that is, improper writing is performed.

Accordingly, in the case of reading, the on resistance of the gate transistor 5 must be higher than the resistance of the second organic EL device 3. This condition is satisfied by use of a configuration in which a selection voltage supplied to the gate line 7 at a read operation is different from the selection voltage supplied at a write operation to apply a potential by which a higher on resistance is obtained. In such a case, the gate voltage of the gate transistor 5 becomes a higher low potential in comparison with that at the write operation.

If the on resistance of the gate transistor 5 is much higher than that of the second organic EL device 3, the potential of the data line 9 may be inverted by the resistance of the second organic EL device 3, while the gate potential of the first drive transistor 2 is maintained low by resistance division, to be set low.

Conversely, when data held in the data line 9 is low, and data held in the gate terminal of the first drive transistor 2 are high, the second drive transistor 4 is turned on. In this case, the potential of the data line 9 may be similarly inverted by use of the on resistance of the second drive transistor 4, while the gate potential of the first drive transistor 2 is maintained high by the higher on resistance of the gate transistor 5, to be set high.

However, these read operations, that is, rewrite operations in which the potential of the data line 9 is rewritten to the gate potential of the first drive transistor 2 are performed through the gate transistor 5 with a higher resistance. Thereby, these operations are slowly performed to require time for reading. Especially, the second organic EL device 3 occupies a smaller area to have a higher resistance, and forms a path on which the device 3 is connected to the gate transistor 5 in series. Accordingly, a certain amount of time is required to invert the potential of the data line 9.

In the above case, the data line 9 may be recommendably precharged at a low potential before starting the read operation for initialization. The only change caused in the data line 9 by the precharging is a change from a low state to a high state, and change from a high state to a low state is caused by series connection of the comparatively low on resistance of the second drive transistor 4 and that of the gate transistor 5, wherein the on resistance of the transistor 4 is higher than that of the transistor 5. Accordingly, the above operation may be performed faster than the read operation which is performed through the second organic EL device 3 and in which the data line 9 is changed from a high state to a low state.

As described above, improper writing over data held in a pixel may be prevented when data is read. Thereby, images continue to be displayed without change, and without being effected by the read operation.

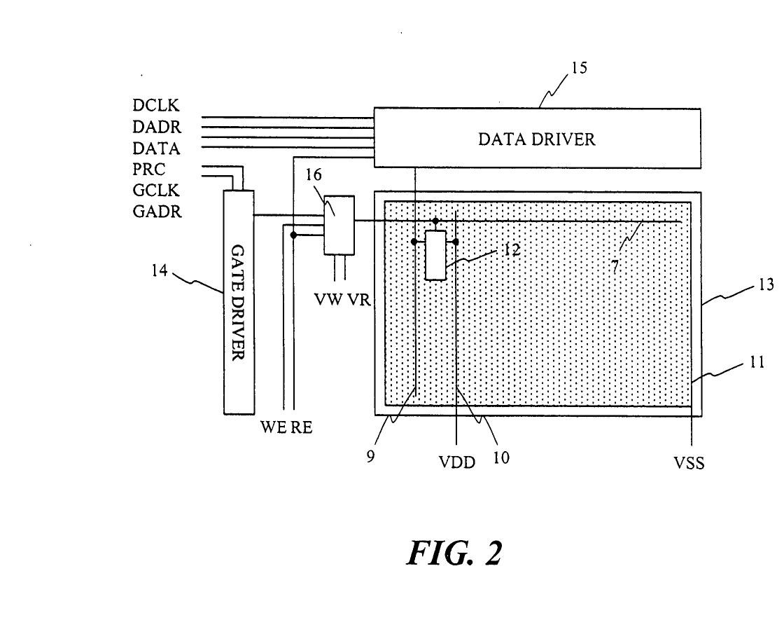

FIG. 2 shows a display device including: a memory pixel array 13 in which the pixels 12 shown in FIG. 1A and FIG. 1B are arranged like a matrix; a gate driver 14 driving the gate line 7; a data driver 15 driving the data line 9; and a voltage selector 16 which switches a selection voltage depending on whether an access mode is a write mode or a read mode.

In the write mode, a write enable signal WE is made high by the voltage selector 16, and the output of the gate driver 14 is converted into a lower selection voltage. On the other hand, in the read mode, a read enable signal RE is made high, and the output of the gate driver 4 is converted into a higher low selection voltage and is output to the gate line 7. When both the write enable signal WE and the read enable signal RE are low, the high output of the gate driver 14 is supplied to the gate line 7, and the gate line 7 enters a non-selective state.

The gate driver 14, the data driver 15, and the voltage selector 16 may be formed of a high-performance low-temperature poly-silicon transistor on the same substrate as that on which the memory pixel array 13 is formed, but it is also acceptable to provide their functions as an integrated circuit (IC). Such an IC may be connected to the substrate on which the memory pixel array 13 is formed using a method such as a chip-on-glass (COG) method.

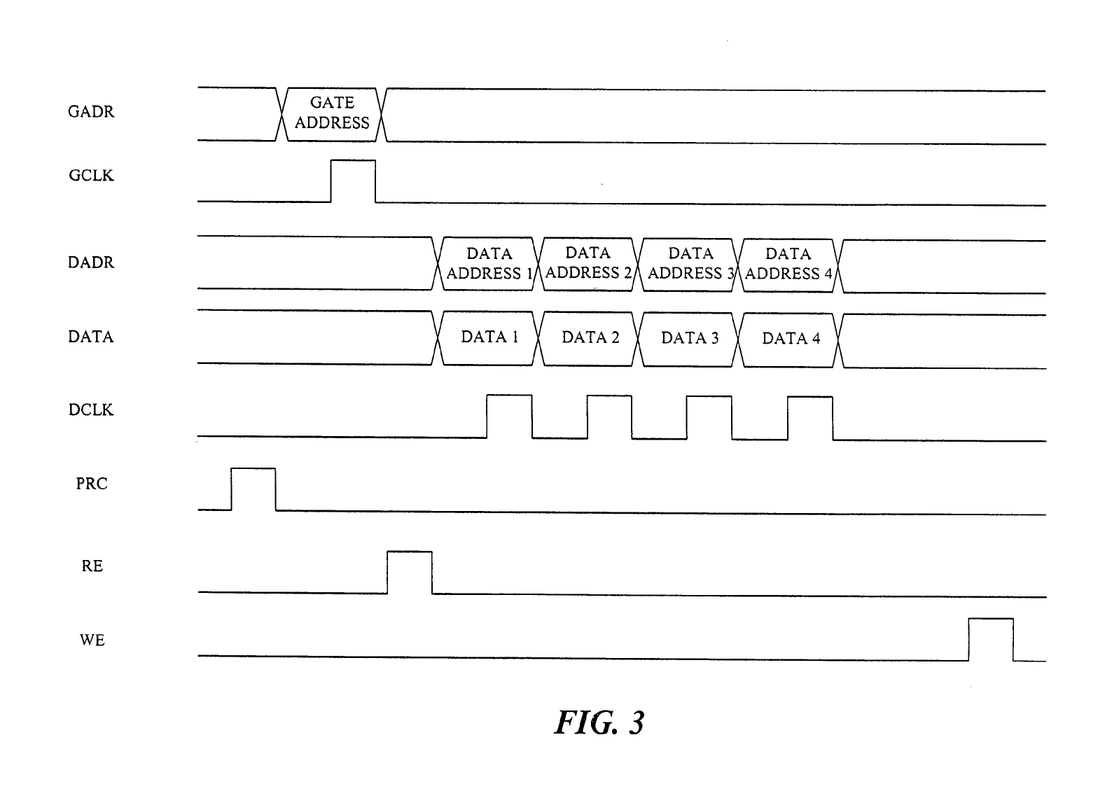

FIG. 3 shows a timing chart for partial writing at which data on a line specified by a gate address in only columns specified by data addresses are rewritten. In the first place, a precharge signal PRC is set high, and the data line 9 is precharged low beforehand. Then, an address of the gate line for writing is input to the gate address input and a timing clock GCLK for capturing the gate address is input to the gate driver 14. Thereby, the input gate address is captured into the gate driver 14.

Then, the read enable signal RE is set high to switch all the outputs of the data driver 15 to an input. Thereby, the data line 9 enters a floating state, and data on a line denoted by a specified gate address is read from the pixel 12 to the data line 9.

Subsequently, an address is input to a data address input DADR of the data driver 15, and, at the same time, data corresponding to the address is input to a data bus DATA to input a clock DCLK for capturing the data. Thereby, connection between the data driver 15 corresponding to the address and the data line 9 is switched from an input state to an output state, and the data is supplied to the data line 9.

When input of the address for writing the data and of the data is completed, the line specified by the gate address is selected by setting the write enable signal WE high to write the data held in the data line 9 onto a pixel. In the above case, the data line 9 which is not specified by an address maintains the data read from a pixel, and, when writing is selected, re-writing is performed. Then, the write enable signal WE becomes low at a stage in which the writing is completed, and the data line 9 becomes a non-selective state, to thereby complete the writing.

Similarly, precharging is completed and a gate address is set when a read operation is performed to read a target line for reading according to timing of the read enable signal RE. In this period, the output of the data driver 15 is switched to the input state, and data specified by a data address is output from the data bus DATA. The write enable signal WE is not applied to a read operation. As described above, a write operation and a read operation may be similarly controlled. Because the write and read operations may be performed on a single line basis when a line buffer is provided in the data driver 15, the write and read operations may be easily realized for contiguous pixels to speed up the memory access.

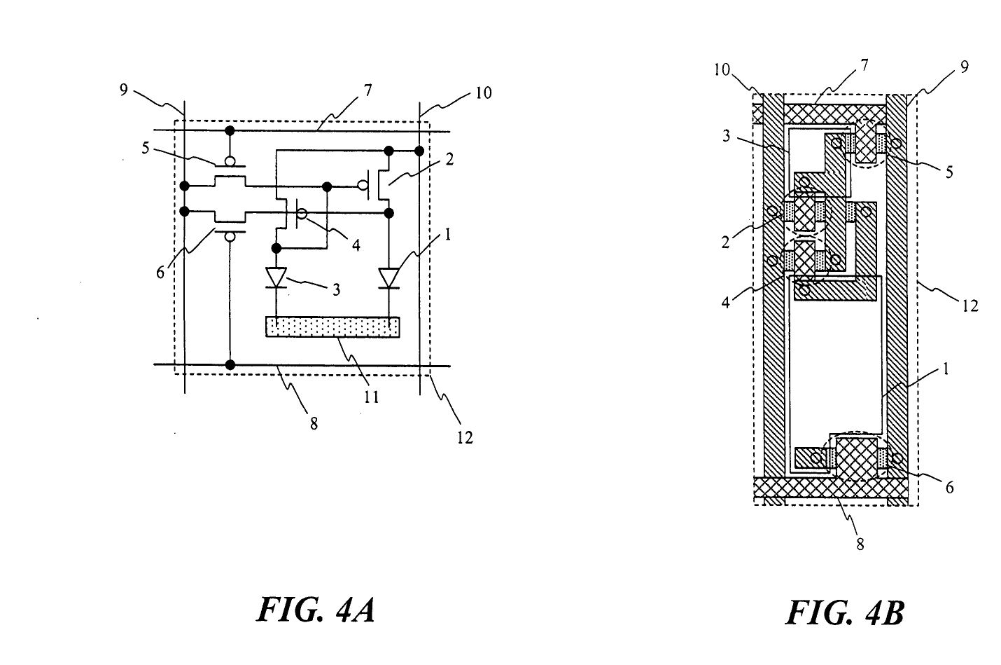

FIG. 4A and FIG. 4B show a pixel with a read speed improved without precharging. A second gate transistor 6 is added to the configuration of the pixel shown in FIG. 1A and FIG. 1B to obtain the configuration shown in FIG. 4A and FIG. 4B. With regard to the above second gate transistor 6, the gate terminal of the second transistor 6 is connected to a second gate line 8, the drain terminal thereof is connected to a data line 9, and the source terminal thereof is connected to the gate terminal of a second drive transistor 4, the anode of a first organic EL device 1, and the drain terminal of a first drive transistor 2.

During a write operation, a first gate line 7 is selected, and data supplied to the data line 9 is written into the pixel in a similar manner to that of the pixel shown in FIG. 1A and FIG. 1B. During a read operation, the second gate line 8 is selected, and data held in a pixel read out to the data line 9.

When low level held in a pixel is read to the data line 9 holding high level, an access point of the second gate transistor 6 is changed, and data obtained by inverting the data held in the gate terminal of the first drive transistor 2 is read. As the data line 9 is connected to the first organic EL device 1 with a resistance lower than that of the second organic EL device 3 through the second gate transistor 6, the high level on the data line 9 may be changed to low level with a more increased speed even without precharging.

Moreover, the pixel shown in FIG. 4A and FIG. 4B may have a configuration in which the first gate transistor 5 is used as a transistor dedicated to write operations, and the second gate transistor 6 is used as a transistor dedicated to read operations. Thereby, the first gate transistor 5 with a lower on resistance and the second gate transistor 6 with a higher on resistance may be obtained by changing the sizes of the two transistors 5 and 6, such as by, for example, shortening the channel length of the first gate transistor 5, and lengthening the channel length of the second gate transistor 6. Accordingly, both on resistances can be automatically controlled at the same selection voltage, even if two separate selection voltages are not prepared for each of the write and read operations.

Similarly as with the pixel shown in FIG. 1A and FIG. 1B, it is recommendable for more reliable reading of data that configuration be adopted in which two selection voltages are provided, the precharging is applied to select the second gate line 8, and inverted data is read through the second gate transistor 6. Here, it is acceptable to provide a read verify function according to which the precharging is further applied again to select the first gate line 7, data is read through the first gate transistor 5, the inverted data read through the second gate transistor 6 and the data read through the first gate transistor 5 are compared, and, when the both data are different from each other, it is judged that the read operation has been normally executed.

Here, when the verify is failed, the read operation is similarly performed again, and the same operation is repeated until the normal read operation is performed. Accordingly, a read operation of data may be performed more reliably.

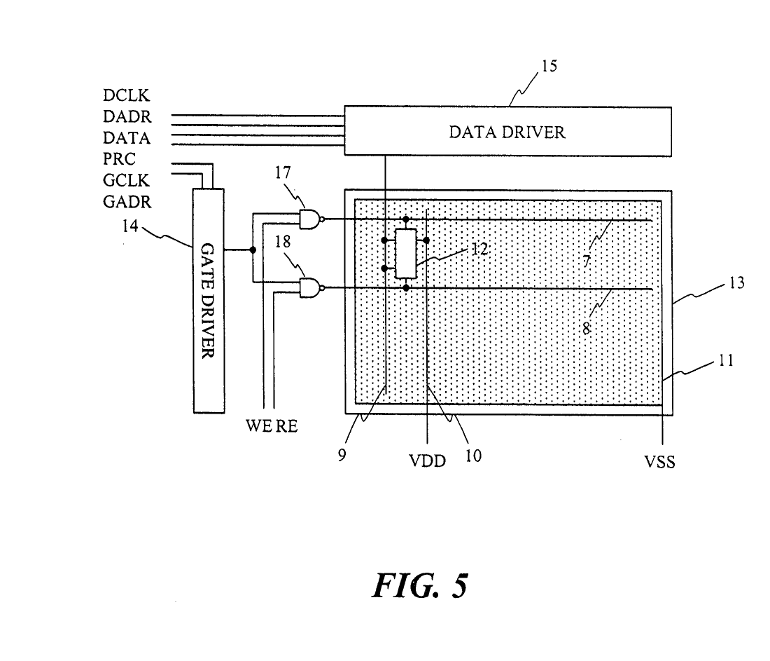

FIG. 5 shows a configuration of a display device adopting the pixel shown in FIG. 4A and FIG. 4B. When a write enable signal WE is set high, the first gate line 7 is selected by a write enable circuit 17 to perform a write operation, and when a read enable signal RE is set high, the second gate line 8 is selected by a read enable circuit 18 to perform a read operation.

At read verify, the write enable signal WE and the selection voltage of the first gate line 7 are simultaneously switched to a low voltage higher than that of the write operation, and the read operation is appropriately executed through the first gate transistor 5.

Thus, when a writable and readable static memory is introduced in a pixel, and is appropriately controlled, only pixel data at an arbitrary address may be rewritten or read even if a frame memory is not introduced as an external component. Furthermore, timing for a read operation is not limited, because the execution of the data read operation has no influences on the display.

An example of a function to which read function of memory data may be effectively applied includes, for example, a scroll function as commonly used for browsing web pages, reading and writing electronic mail, and the like. During scrolling, a portion of a page is displayed because the entire page cannot be displayed in the allotted area at the determined resolution, and an area which is not currently displayed can be brought into view on the screen by scrolling the image in a vertical and horizontal manner. As this function is realized simply by parallel motion of data in a pixel memory, the function may be easily executed using a configuration in which data which has already been in the pixel memory is read for parallel motion, and data newly added to the data driver 15 for displaying is transferred. As the only data to be transferred to the data driver 15 is newly added data, the amount of data to be transferred, and, furthermore, the power consumption, may be greatly reduced.

Moreover, the readable and writable pixels shown in FIG. 1A, FIG. 1B, FIG. 4A, and FIG. 4B may be used as a normal memory arranged outside a display area. Such a case may be preferable when the organic EL device forms a non-light emitting device, or a device generating light other than visible light, because the pixels shown in FIG. 1A, FIG. 1B, FIG. 4A, and FIG. 4B emits light according to its on or off state. As described above, it is not preferable to form a light emitting device and a non-light emitting device in a display area, because such a configuration requires use of a mask with a higher accuracy. However, forming only a non-light emitting device outside the display area is a relatively simple task.

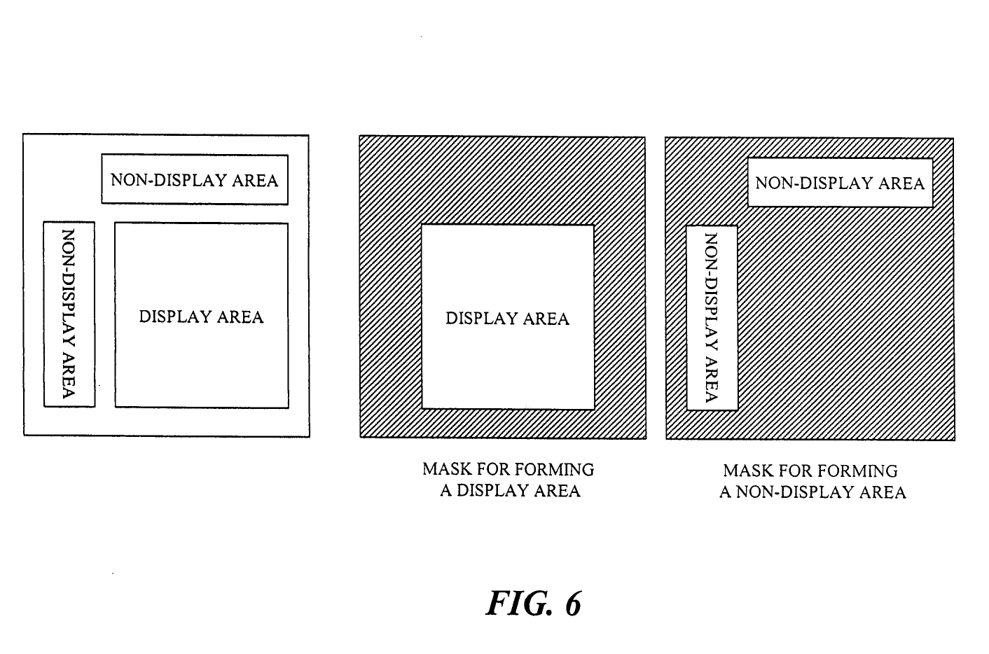

FIG. 6 is a schematic view of masks for forming a light emitting type organic EL device in a display area and forming a non-light emitting type organic EL device in a non-display area. When, for example, a light-emitting layer is eliminated in order to form a non-light emitting type organic EL device in a non-display area, the light-emitting layer is not deposited on the non-display area by a configuration in which the mask, shown in FIG. 6, for forming a display area is used when the light-emitting layer is deposited. Moreover, when it is required to deposit a special film only on the non-display area, the special film may be deposited only on the non-display area using the mask for forming a non-display area.

The non-light emitting type organic EL device formed in the non-display area may obviously be used for a portion of circuits in the gate driver 14 and the data driver 15, or as an additional memory for holding data and the like. Moreover, the EL device may be applied to a circuit such as a touch sensor used for position control of a mouse pointer.

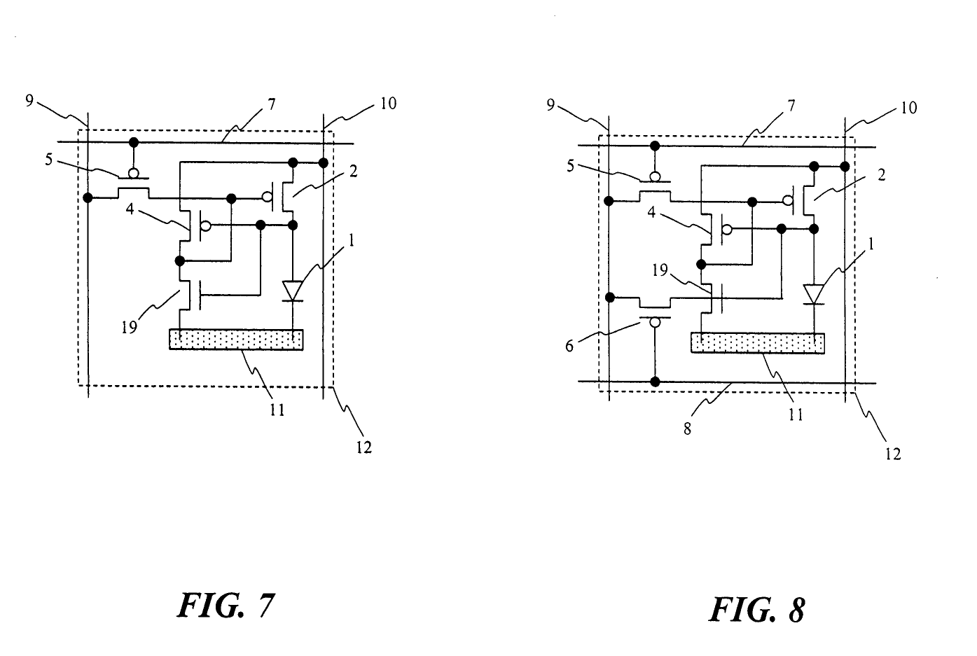

The pixel 12 shown in FIG. 1A, FIG. 1B, FIG. 4A, and FIG. 4B is configured to use only a P-type transistor according to a P-channel metal oxide semiconductor (PMOS) process with a lower cost. When a complementary metal oxide semiconductor (CMOS) process may be used, the pixel 12 may have a configuration in which the second organic EL device 3 is replaced with an N-type transistor 19 as shown in FIG. 7 and FIG. 8, wherein the gate terminal of the transistor 19 is connected to the anode of a first organic EL device 1, the drain terminal of a first drive transistor 2, and the gate terminal of a second drive transistor 4, the drain terminal of the transistor 19 is connected to the gate terminal of the first drive transistor 2, the drain terminal of the second drive transistor 4, and the source terminal of a first gate transistor 5, and the source terminal of the terminal 19 is connected to a cathode electrode 11.

As the N-type transistor 19 is turned off and a current passing through the second organic EL device 3 when the first organic EL device 1 is in a non-light emitting state is cut by replacing the second organic EL device 3 with the N-type transistor 19 as shown in FIG. 7 and FIG. 8, a static memory pixel in which write and read operations may be performed with lower electric power consumption may be formed.

Moreover, the configuration of the active matrix type display device according to the present embodiment is not limited to the example of a black and white (monochrome) and one bit tone display, but may be applied to full color displays in which similar pixels are provided as sub pixels displaying colors such as a red (R), a green (G), a blue (B), white (W), or the like. Moreover, a multi-tone display device may be realized by further dividing sub pixels of each color into a plurality of divided pixels emitting light of varied intensities, and by writing each bit data into a divided pixel generating light emitting intensity corresponding to the weight of the bit data.

Furthermore, although an organic EL device was used was described as an example of the light emitting device in the above-described embodiment, the present invention may also be used in conjunction with a current drive type light emitting device, such as a light emitting diode or the like.

### PARTS LIST

1 EL device
2 drive transistor
3 EL device
4 drive transistor
5 gate transistor
6 gate transistor
7 gate line
8 gate line
9 data line
10 power supply line
11 cathode electrode
12 pixels
13 pixel array
14 gate driver
15 data driver
16 voltage selector
17 write enable circuit
19 gate terminal

1. An active matrix type display device, comprising:
a plurality of pixels arranged in a matrix;
data lines arranged along the column direction of pixels, and on which data for pixels corresponding to columns is set;
selection lines which are arranged along the row direction of pixels, and on which selection signals for pixels corresponding to rows are set; wherein
each pixel includes:
a selection transistor which is turned on or off by a selection signal on the selection line;
a static memory connected to the data line through the selection transistor; and
a light emitting device undergoing control of light emitting according to the storage state of the static memory, and,
means effective in a write mode, to turn the selection transistor on, and, at the same time, causing data on the data line to be set to write the set data in the static memory, and
means effective in a read mode, to turn the selection transistor on, and, at the same time, causing the data line to be set to a floating state, and the stored content of the static memory is read onto the data line.

2. The active matrix type display device according to claim 1, wherein:
the light emitting device includes a first light emitting device and a second light emitting device, one of the devices being shielded and the other being not shielded,
the static memory includes:
a first drive transistor which is connected to the first light emitting device and controls a current input to the first light emitting device; and
a second drive transistor which is connected to the second light emitting device and controls a current input to the second light emitting device, and
the control terminal of the first light emitting device is connected to a data line through the selection transistor, and, at the same time, is connected to a node of the second drive transistor and the second light emitting device, the control terminal of the second light emitting device being connected to a node of the first drive transistor and the first light emitting device, and
data is written from a data line through the selection transistor, wherein either of the first drive transistor or a second transistor is turned on according to data supplied to the control terminal of a first transistor.

3. The active matrix type display device according to claim 2, wherein:
the on resistance of the selection transistor is set to a value higher than the resistance of the second light emitting device and the on resistance of the second drive transistor.

4. The active matrix type display device according to claim 2, wherein:
data may be read onto a data line by a configuration in which the on resistance of the selection transistor is set higher than that of the second drive transistor, and, at the same time,
the data line is precharged before a read operation of the data is started in a read mode to make the on resistance of the selection transistor higher than that of the second drive transistor.

5. The active matrix type display device according to claim 2, wherein:
the on resistance in a read mode is made higher in comparison with that in a write mode by employing a configuration in which a voltage level of a selection signal supplied to the selection line is set higher in the write mode, and lower in the read mode.

6. The active matrix type display device according to claim 2, wherein:
a data line is further provided with a second selection transistor connecting the control terminal of the second drive transistor and the node of the first drive transistor and the first light emitting device,
one of the on resistance of the selection transistor and that of the second selection transistor is set higher than the other one, and
in a write mode, the selection transistor with a lower on resistance is turned on, and, in a read mode, the selection transistor with a higher on resistance is turned on.

7. The active matrix type display device according to claim 6, wherein:
in a read operation of data, data read through one of the two selection transistors and inverted data read through the other the selection transistor are compared for verifying of the read data.

8. The active matrix type display device according to claim 1, wherein:
a portion of the pixels functioning as the light emitting device through which a current passes do not emit visible light at that time, and the portion of pixels which do not emit light are used as a data writable and readable memory.

9. The active matrix type display device according to claim 1, wherein:
the light emitting device is an organic EL device.
